(19) United States
(12) Patent Application Publication
(10) Pub. No.: US 2007/0230406 A1
(43) Pub. Date: Oct. 4, 2007

(54) Apparatus and method for transmitting/receiving packet data in a mobile communication system

(75) Inventors: Dong-Hee Kim, Yongin-si (KR); Beom-Sik Bae, Suwon-si (KR); Hwan-Joon Kwon, Hwascong-si (KR); Jae-Chon Yu, Suwon-si (KR); Jin-Hyu Han, Seoul (KR); Yu-Chul Kim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/726,738

(22) Filed: Mar. 22, 2007

(30) Foreign Application Priority Data
Mar. 22, 2006 (KR) 2006-26301

(51) Int. Cl. H04B 7/216

(52) U.S. Cl. 370/335

(57) ABSTRACT

A packet data transmitting/receiving method in a mobile communication system. The transmission method includes determining whether to transmit a plurality of packet data in one slot; and transmitting a Primary Control Preamble (PCP) having a specific preamble pattern, a coded control channel, and packet data, if it is determined to transmit a plurality of packet data in one slot. The reception method includes detecting a preamble from a signal received from a base station; determining whether the detected preamble is a Primary Control Preamble (PCP) having a specific preamble pattern; decoding coded control channels, and checking a Media Access Control Identifier (MAC ID) in the decoded control channels, if the detected preamble is a PCP; determining whether the MAC ID in the control channels is identical to a MAC ID of a terminal; and decoding corresponding packet data if the MAC IDs are identical.

### PRIORITY

This application claims priority under 35 U.S.C. §119(a) to a Korean Patent Application filed in the Korean Intellectual Property Office on Mar. 22, 2006 and assigned Serial No. 2006-26301, the disclosure of which is incorporated herein by reference.

### BACKGROUND OF THE INVENTION

1. Field of the Invention

The present invention relates generally to an apparatus and method for transmitting/receiving packet data in a mobile communication system, and in particular, to an apparatus and method for transmitting/receiving a plurality of packet data in a mobile communication system.

2. Description of the Related Art

Generally, mobile communication systems for transmitting high-speed packet data can be roughly classified into a system supporting only data transmission, and a system supporting both the data transmission and also voice transmission. The mobile communication systems for high-speed packet data transmission use high-speed packet data transmission channels. The high-speed packet data transmission channel (for example, the Packet Data Channel (PDCH) of 1xEVDO and 1xEVDV) is shared by several users on a Time Division Multiplexing (TDM) basis in order to transmit high-speed data.

In the mobile communication system for high-speed packet data transmission, a transmitter transmits various control information for the data, which is TDM-transmitted over the high-speed packet data transmission channel at a particular time, over a Packet Data Control Channel (PDCCH), or a preamble channel. Several users desiring to receive a data service over the high-speed packet data transmission channel must previously receive control information for the data transmitted at a specific time, because they have no information on a target user of the data, a data transmission length, a data rate, and a modulation scheme.

The control information for packet data includes sub-packet length information, Media Access Control (MAC) ID, data rate, modulation scheme, payload size, Sub-Packet ID (SPID), Automatic Repeat reQuest (ARQ) channel ID, etc. As described above, in the mobile communication system for high-speed packet data transmission, a transmission unit of the data transmitted over the high-speed packet data transmission channel is called a sub-packet, and the sub-packet length information refers to a time length of the data, which is TDM-transmitted over the high-speed packet data transmission channel, and is necessarily provided to users in the system whose data transmission length is variable. The MAC ID is an identifier for user identification, and a MAC ID is allocated to each user desiring to receive a high-speed packet data service during system access. The data rate is a transfer rate of the data transmitted with a time length defined by the sub-packet length information, and the modulation scheme indicates one of the possible modulation schemes, such as Quadrature Phase Shift Keying (QPSK), 8-ary PSK (8PSK), 16-ary Quadrature Amplitude Modulation (16QAM), 64-ary QAM (64QAM), etc., with which the transmission data is modulated. The payload size refers to the number of information bits constituting one sub-packet, and the SPID, an identifier for each of sequential sub-packets, is used for supporting retransmission. The ARQ channel ID, an identifier for supporting continuous data transmission to one user, is used for identifying parallel transmission channels.

During system access, each terminal desiring to receive the high-speed packet data service, is allocated a unique MAC ID, receives a packet data control channel, demodulates the received channel, and determines whether received packet data belongs to its own packet depending on a MAC ID in the demodulated channel, and decodes the packet data if the received packet data belongs to its own packet.

FIG. 1 illustrates a packet data transmission/reception method in a conventional mobile communication system. Specifically, FIG. 1 illustrates a preamble/data transmission method in which one packet is transmitted in one slot in the conventional mobile communication system.

A terminal measures a channel state of a forward link and transmits Data Rate Control (DRC) to a base station every slot. The base station performs scheduling for determining to which terminal it will transmit packet data in the current slot, using the DRC information received from several terminals. If the terminal to which the packet data is to be transmitted in the current slot is determined, the base station transmits packet data 120 to the corresponding terminal at a data rate corresponding to the DRC transmitted from the corresponding terminal. During the packet data transmission to the terminal, in order to provide the terminal with information indicating the transmission of packet data, the base station uses a preamble 110 mapped to a MAC ID of the corresponding terminal, as shown in FIG. 1.

Upon receiving a preamble mapped to its own MAC ID, the terminal receives the packet data, determining that a packet has been transmitted to the terminal itself.

The conventional technology could transmit only one packet data for one terminal in one slot with use of a preamble having a MAC ID of the corresponding terminal. This preamble structure is efficient for the case where only one packet data is transmitted in one slot, but is inefficient for the case where a plurality of packet data is transmitted in one slot or the case where a base station transmits a packet at a data rate being different from the data rate corresponding to the DRC transmitted by a terminal, because the amount of control information additionally needed for demodulation of received packet data at the terminal increases.

### SUMMARY OF THE INVENTION

An aspect of the present invention is to address at least the problems and/or disadvantages and to provide at least the advantages described below. Accordingly, an aspect of the present invention is to provide a packet data transmission/reception apparatus and method suitable for diversification of the number of packet data allocated to one slot and of data rates in a mobile communication system, thereby minimizing use of resources used for packet data transmission.

Another aspect of the present invention is to provide an apparatus and method for transmitting a plurality of packet data in one slot in a mobile communication system.

Another aspect of the present invention is to provide an apparatus and method for transmitting a plurality of packet data in one slot using a Primary Control Preamble (PCP).

Another aspect of the present invention is to provide an apparatus and method for transmitting a plurality of packet data in one slot when blind-decoding a coded control channel.

Another aspect of the present invention is to provide an apparatus and method for transmitting a plurality of packet data in one slot when superposition-coding a PCP and a coded control channel.

Another aspect of the present invention is to provide an apparatus and method for transmitting a plurality of packet data in one slot by transmitting packet data separately for a plurality of sub-bands constituting one slot.

Another aspect of the present invention is to provide an apparatus and method for transmitting a plurality of packet data in one slot by transmitting a plurality of packet data over multiple bands.

According to one aspect of the present invention, there is provided a method for transmitting packet data in a mobile communication system. The transmission method includes determining whether to transmit a plurality of packet data in one slot; and transmitting a Primary Control Preamble (PCP) having a specific preamble pattern, a coded control channel, and packet data, if it is determined to transmit a plurality of packet data in one slot.

According to another aspect of the present invention, there is provided a method for receiving packet data in a mobile communication system. The reception method includes detecting a preamble from a signal received from a base station; determining whether the detected preamble is a Primary Control Preamble (PCP) having a specific preamble pattern; decoding coded control channels, and checking a Media Access Control Identifier (MAC ID) in the decoded control channels, if the detected preamble is a PCP; determining whether the MAC ID in the control channels is identical to a MAC ID of a terminal; and decoding corresponding packet data if the MAC IDs are identical.

According to further another aspect of the present invention, there is provided an apparatus for transmitting packet data in a mobile communication system. The transmission apparatus includes a scheduler for determining to which terminal it will transmit packet data in a current slot, using Data Rate Control (DRC) information received from a plurality of terminals; and a controller for controlling transmission of a Primary Control Preamble (PCP) having a specific preamble pattern, a coded control channel and packet data according to the scheduling result, if it transmits a plurality of packet data in one slot.

According to further another aspect of the present invention, there is provided an apparatus for receiving packet data in a mobile communication system. The reception apparatus includes a detector for detecting a preamble and a coded control channel, received from a base station, and providing detected information; and a controller for controlling decoding of a plurality of packet data according to the detected information.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating a packet data transmission/reception method in a conventional mobile communication system e.g., a cdma2000 HRPD system (1xEV-DO);

FIGS. 2 to 4 are diagrams illustrating packet data transmission/reception methods in a mobile communication system according to a first embodiment of the present invention;

FIGS. 5 to 7 are diagrams illustrating packet data transmission/reception methods in a mobile communication system according to a second embodiment of the present invention;

FIGS. 8 to 10 are diagrams illustrating packet data transmission/reception methods in a mobile communication system according to a third embodiment of the present invention;

FIGS. 11 to 13 are diagrams illustrating packet data transmission/reception methods in a mobile communication system according to a fourth embodiment of the present invention;

FIGS. 14 to 16 are diagrams illustrating packet data transmission/reception methods in a mobile communication system according to a fifth embodiment of the present invention;

FIG. 17 illustrates an exemplary application of the fourth and fifth embodiments of the present invention;

FIG. 18 illustrates a structure of a base station's transmission apparatus according to the present invention; and

FIG. 19 illustrates a structure of a terminal's reception apparatus according to the present invention.

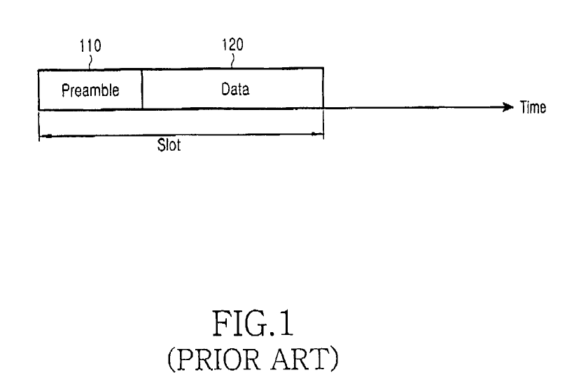

### DETAILED DESCRIPTION OF EXEMPLARY EMBODIMENTS

Exemplary embodiments of the present invention will now be described in detail with reference to the annexed drawings. In the following description, a detailed description of known functions and configurations incorporated herein has been omitted for clarity and conciseness.

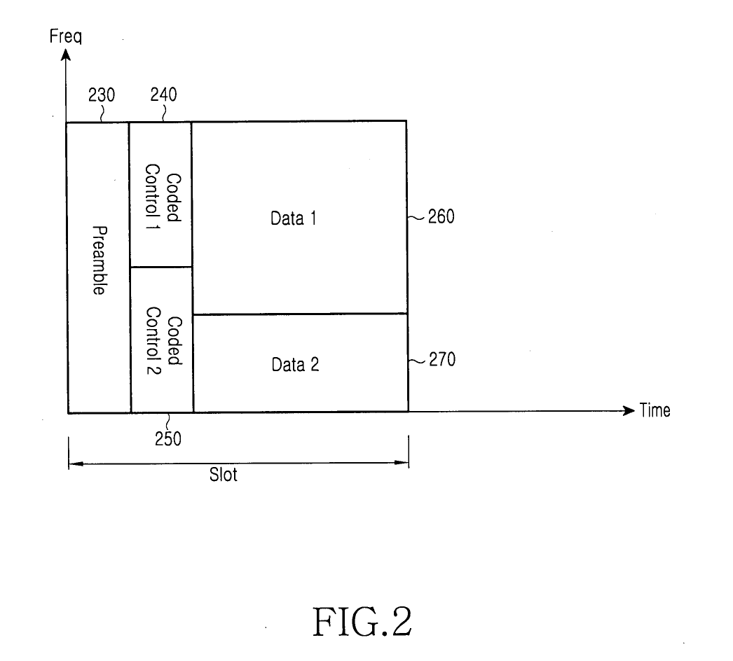

FIGS. 2 to 4 illustrate packet data transmission/reception methods in a mobile communication system according to a first embodiment of the present invention. Specifically, FIG. 2 illustrates a packet data transmission/reception method in which a plurality of packet data is transmitted in one slot.

Referring to FIG. 2, during packet data transmission to a terminal, in order to provide the terminal with information indicating the transmission of a plurality of packet data, a base station includes, in one slot, a Primary Control Preamble (PCP) 230 having a specific preamble pattern, coded control channels 240 and 250, and a plurality of packet data 260 and 270.

The coded control channels 240 and 250 transmitted together with the PCP 230 include a MAC ID to indicate to which terminal the corresponding packet data is to be transmitted, and also include control information used for receiving such data as sub-carrier allocation to corresponding packet data, data rate, and multi-antenna transmission scheme. The base station separately allocates frequency/time resources to transmit the coded control channels.

The base station previously determines a specific PCP through negotiation with terminals. The base station can define a plurality of PCP patterns, and with their use, the base station can indicate the number (or size) of coded control channels (or the number of bits) transmitted together with a PCP. For example, use of a preamble pattern PCP1 means that two coded control channels are included in a corresponding slot, and use of a preamble pattern PCP2 means that four coded control channels are included in a corresponding slot.

If Orthogonal Frequency Division Multiplexing (OFDM) is used, the PCP can indicate sub-carrier mapping for the coded control channels transmitted together.

For example, as mentioned above, use of a preamble pattern PCP1 means that two coded control channels are included in a corresponding slot, and of the channels, a first coded control channel is transmitted through odd sub-carriers and a second coded control channel is transmitted through even sub-carriers.

In addition, as mentioned above, use of a preamble pattern PCP2 means that four coded control channels are included in a corresponding slot, and of the channels, a first coded control channel is transmitted through upper half sub-carriers and a second coded control channel is transmitted through lower half sub-carriers.

Besides, with use of multiple PCP patterns, it is possible to indicate a modulation scheme of control channels, multi-antenna transmission scheme-related information of packet data, a data rate, and sub-carrier allocation for packet data. In this case, the coded control channels may not be needed. However, because an increase in such information affects preamble reception performance, the related information should be minimized and expressed with PCP patterns.

It will be assumed herein that the PCP pattern indicates the number (or size) of coded control channels (or the number of bits).

If a terminal receives a PCP and detects from its pattern the number (or size) of coded control channels (or the number of bits) of coded control channels, the terminal can receive the coded control channels. If the terminal receives the coded control channels and detects receipt of a control channel corresponding to its own MAC ID, the terminal receives corresponding packet data.

With reference to FIGS. 2 to 4, a description will now be made of a packet data transmission/reception method in a mobile communication system according to the first embodiment of the present invention.

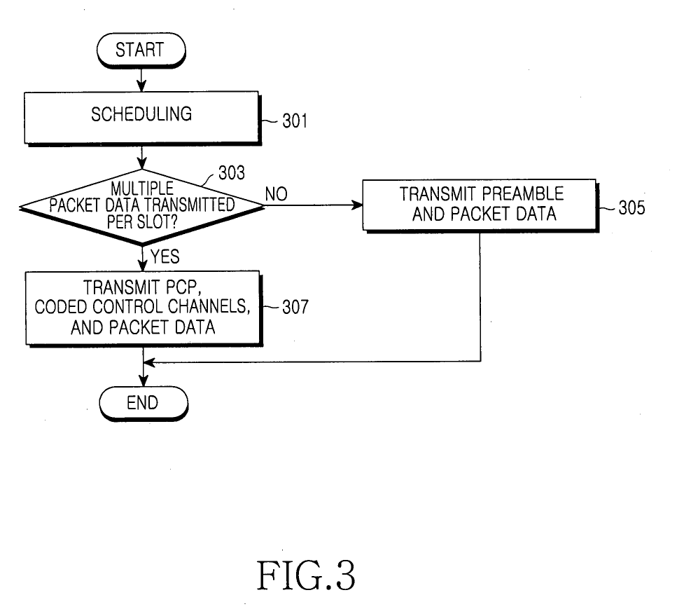

FIG. 3 illustrates a procedure for transmitting packet data in a base station's transmission apparatus according to the first embodiment of the present invention.

Referring to FIG. 3, the base station performs scheduling in step 301. Specifically, the base station performs scheduling for determining to which terminal it will transmit packet data in the current slot, using DRC information received from several terminals.

The base station determines in step 303 whether it will transmit a plurality of packet data in one slot. If the base station determines to transmit one packet data in one slot, it transmits a preamble and packet data to a terminal in the conventional manner in step 305. In this case, the base station transmits a preamble mapped to a MAC ID of the terminal, and then transmits desired packet data to the terminal.

However, if the base station determines to transmit a plurality of packet data in one slot, it transmits coded control channels 240 and 250, and packet data 260 and 270 to the terminal in step 307. In this case, the PCP 230 includes information on the number of coded control channels transmitted together with it. The coded control channels 240 and 250, transmitted together with the PCP 230, transmit a MAC ID to indicate to which terminal the corresponding packet data is to be transmitted, and include therein control information used for receiving such data as sub-carrier allocation to corresponding packet data, data rate, and multi-antenna transmission scheme.

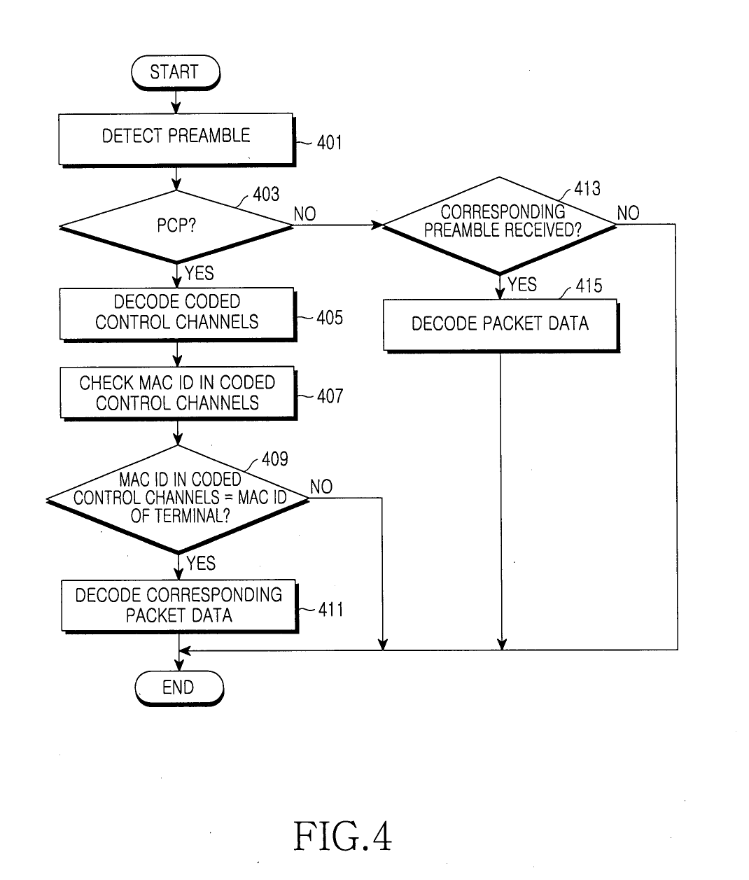

FIG. 4 illustrates a procedure for receiving packet data in a terminal's reception apparatus according to the first embodiment of the present invention.

Referring to FIG. 4, the terminal detects a preamble 230 in step 401. The terminal determines in step 403 whether the received preamble is a PCP. If the terminal detects the number of coded control channels from a PCP received, it can receive the coded control channels.

If it is determined in step 403 that the received preamble is a PCP, the terminal decodes the coded control channels in step 405. The terminal checks the MAC ID in the coded control channels in step 407, and determines in step 409 whether a MAC ID in the decoded coded control channels is identical to its own MAC ID. That is, the terminal determines whether the received coded control channels are control channels corresponding to its own MAC ID.

If it is determined in step 409 that the MAC ID in the coded control channels is not identical to its own MAC ID, the terminal ends the procedure. However, if they are identical, the terminal decodes the corresponding packet data in step 411. That is, if the received coded control channels are control channels corresponding to its own MAC ID, the terminal receives the corresponding packet data.

However, in step 403, if it is determined that the received preamble is not a PCP, the terminal determines in step 413 whether it has received a preamble corresponding to its own MAC ID. If the terminal has failed to receive a preamble corresponding to its own MAC ID, it ends the procedure. However, if the terminal has received a preamble corresponding to its own MAC ID, it decodes the corresponding packet data in step 415. The operation performed in steps 413 and 415 is the same as that in the prior art.

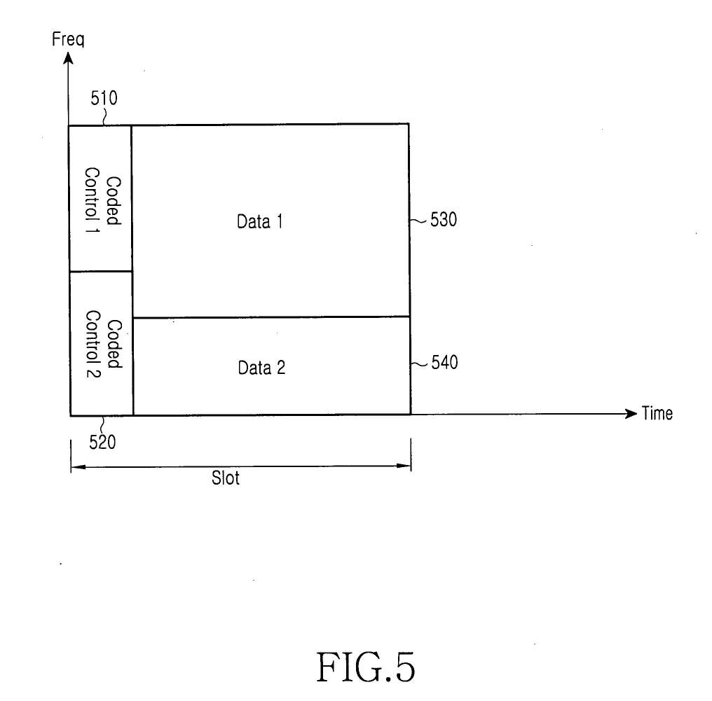

FIG. 5 illustrates a packet data transmission/reception method in a mobile communication system according to a second embodiment of the present invention. The method shown in FIG. 5, in which a plurality of packet data is transmitted in one slot, transmits coded control information and data when performing Blind Detection (BD) on coded control channels.

During packet data transmission to a terminal, in order to provide the terminal with information indicating the transmission of a plurality of packet data, a base station includes coded control channels 510 and 520, and packet data 530 and 540 in one slot without the PCP, unlike the slot structure described in FIG. 2.

If the base station transmits packet data in this manner, a terminal performs BD on a preamble and coded control channels every slot, and receives packet data upon receiving a preamble or coded control channels corresponding to its own MAC ID.

With reference to FIGS. 5 to 7, a description will now be made of a packet data transmission/reception method in a mobile communication system according to the second embodiment of the present invention.

In the second embodiment of the present invention, a terminal checks whether coded control channels transmitted without the PCP are transmitted at a position with a transmission scheme, both of which are previously defined with the base station. In addition, the terminal checks a Cyclic Redundancy Code (CRC). As a result, if a MAC ID included in received coded control channels is identical to its own MAC ID, the terminal receives the corresponding packet data.

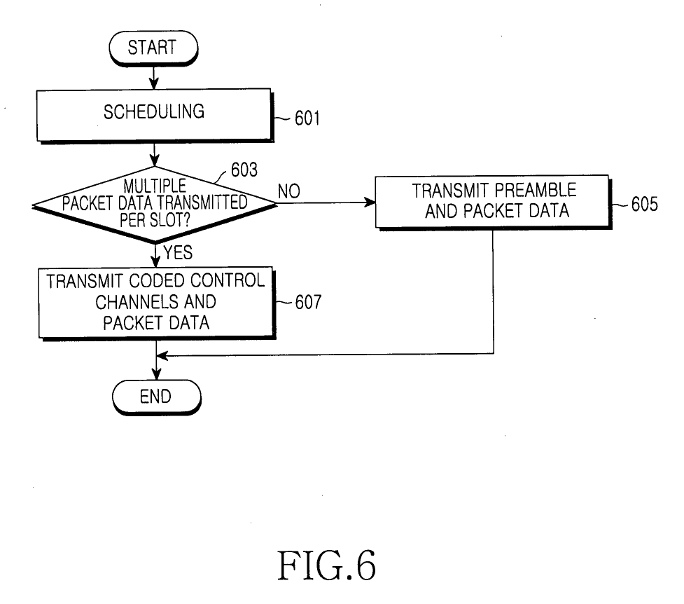

FIG. 6 illustrates a procedure for transmitting packet data in a base station's transmission apparatus according to the second embodiment of the present invention.

Referring to FIG. 6, the base station performs scheduling in step 601. Specifically, the base station determines to which terminal it will transmit packet data in the current slot, using DRC information received from several terminals.

The base station determines in step 603 whether it will transmit a plurality of packet data in one slot. If the base station determines to transmit one packet data in one slot, it transmits a preamble and packet data to a terminal in the conventional manner in step 605. In this case, the base station transmits a preamble having a MAC ID mapped to a MAC ID of the terminal, and then transmits desired packet data to the terminal.

However, if the base station determines to transmit a plurality of packet data in one slot, it transmits coded control channels 510 and 520, and packet data 530 and 540 to the terminal in step 607, as described in FIG. 5.

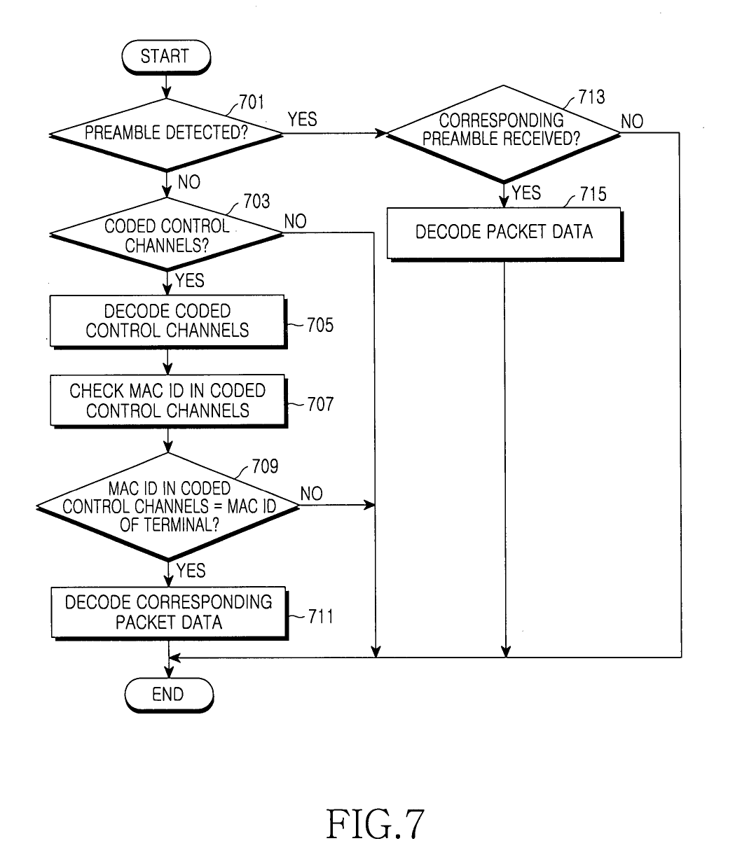

FIG. 7 illustrates a procedure for receiving packet control channels in a terminal's reception apparatus according to the second embodiment of the present invention.

Referring to FIG. 7, the terminal determines in step 701 whether it has detected a preamble. If the terminal has failed to detect a preamble, it determines in step 703 whether it has received coded control channels. If the terminal has failed to receive coded control channels, it ends the packet control channel reception procedure because it has failed to receive both the preamble and the coded control channels. However, if the terminal has received coded control channels, it decodes the coded control channels in step 705. Thereafter, the terminal checks a MAC ID included in the coded control channels in step 707. After the CRC check, the terminal determines in step 709 whether the MAC ID included in the coded control channels is identical to its own MAC ID. That is, the terminal determines whether the received coded control channels are control channels corresponding to its own MAC ID.

If the MAC ID included in the coded control channels is not identical to its own MAC ID, the terminal ends the procedure. However, if they are identical, the terminal decodes the corresponding packet data in step 711. That is, if the received coded control channels are control channels corresponding to its own MAC ID, the terminal receives the corresponding packet data.

However, in step 701, if the terminal has succeeded in receiving a preamble, the terminal determines in step 713 whether the received preamble corresponds to its own MAC ID. If the received preamble does not correspond to its own MAC ID, the terminal ends the procedure.

However, if the received preamble corresponds to its own MAC ID, the terminal decodes the corresponding packet data in step 715.

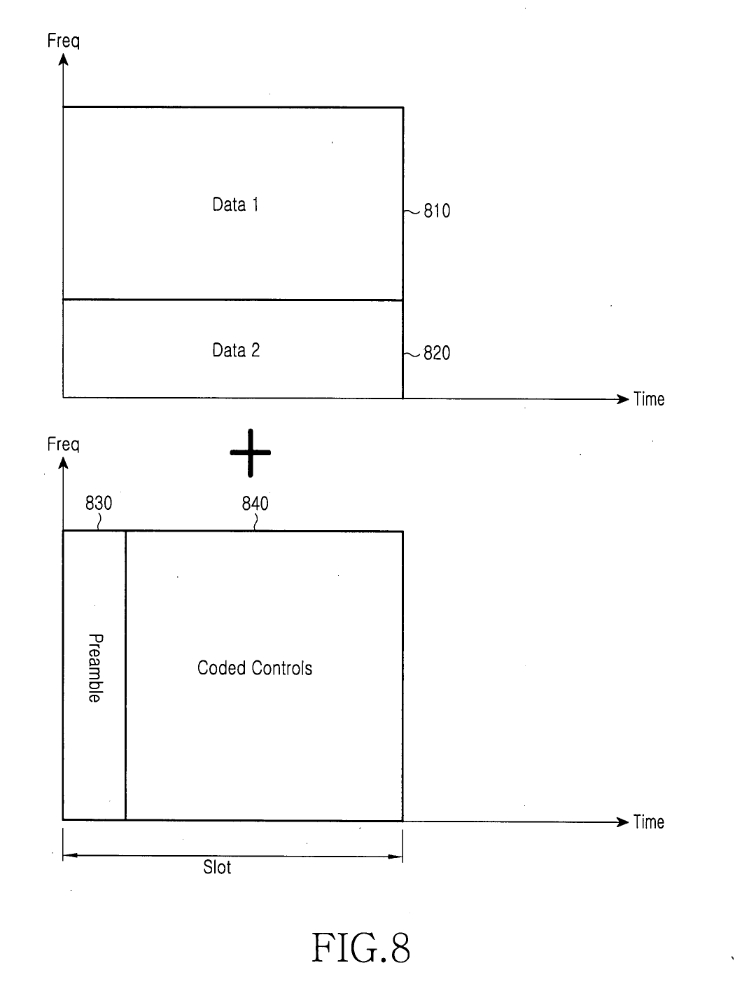

FIG. 8 illustrates a packet data transmission/reception method in a mobile communication system according to a third embodiment of the present invention. The method shown in FIG. 8, in which a plurality of packet data is transmitted in one slot, transmits coded control information and data when a PCP and a coded control channel undergo superposition coding.

The term ‘superposition coding’ refers to an operation in which a base station intactly adds two independent signals sample by sample before transmission. In this case, a terminal first receives one of them, cancels interference therefrom through an interference canceller (not shown) after success in decoding, and then receives the other signal.

The base station uses a PCP 830 to provide information indicating transmission of a plurality of packet data, and intactly adds a coded control channel 840 to packet data 810 and 820 before transmission without separately allocating frequency/time resources for the coded control channel 840. This means the foregoing superposition coding operation.

During transmission of the superposition-coded PCP 830 and coded control channel 840, interference may occur. In order to cancel the interference, the terminal, after receiving the PCP 830 and the coded control channel 840, cancels interference therefrom using an interference canceller. After interference cancellation, the terminal receives packet data 810 and 820.

The PCP 830, like that in FIG. 2, can transmit information (for example, the number of coded control channels) used for receiving a coded control channel, and an increase in the amount of information causes an increase in the number of PCP patterns.

The coded control channel 840, like that in FIG. 2, transmits a MAC ID to provide information indicating to which terminal the corresponding packet data is transmitted, and also transmits control information used for receiving such data as sub-carrier allocation to a corresponding packet, data rate, and multi-antenna transmission scheme.

When the scheme of FIG. 8 is used together with a multi-carrier scheme that uses multiple carriers, if a PCP is received on several carriers, a coded control channel can be transmitted over several carriers on which the PCP is received, in order to acquire frequency diversity. That is, one coded control channel can be transmitted using frequency/time resources of several carriers on which the PCP is received, rather than transmitting the coded control channel independently for each individual carrier.

With reference to FIGS. 8 to 10, a description will now be made of a packet data transmission/reception method in a mobile communication system according to the third embodiment of the present invention.

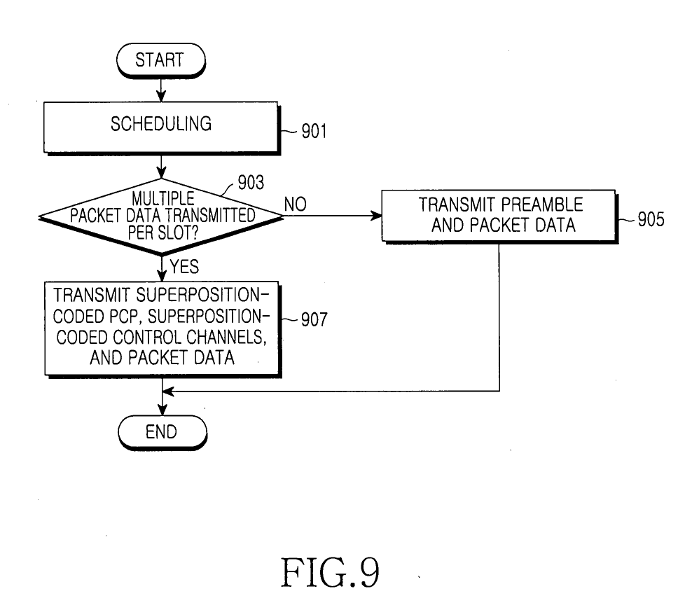

FIG. 9 illustrates a procedure for transmitting packet data in a base station's transmission apparatus according to the third embodiment of the present invention.

Referring to FIG. 9, the base station performs scheduling in step 901. Specifically, the base station determines to which terminal it will transmit packet data in the current slot, using DRC information received from several terminals.

The base station determines in step 903 whether it will transmit a plurality of packet data in one slot. If the base station determines to transmit one packet data in one slot, it transmits a preamble and packet data to a terminal in the conventional manner in step 905. In this case, the base station transmits a preamble having a MAC ID mapped to a MAC ID of the terminal, and then transmits desired packet data to the terminal.

However, if the base station determines to transmit a plurality of packet data in one slot, it adds PCP 830 and a coded control channel 840 to packet data 810 and 820, and then transmits the results to the terminal in step 907. That is, the base station transmits the superposition-coded PCP, the superposition-coded control channel 840, and the packet data 810 and 820 to the terminal. The superposition-coded control channel transmitted together with the superposition-coded PCP 830 transmits a MAC ID to provide information indicating to which terminal the corresponding packet data is transmitted, and includes control information used for receiving such data as sub-carrier allocation to a corresponding packet, data rate, and multi-antenna transmission scheme.

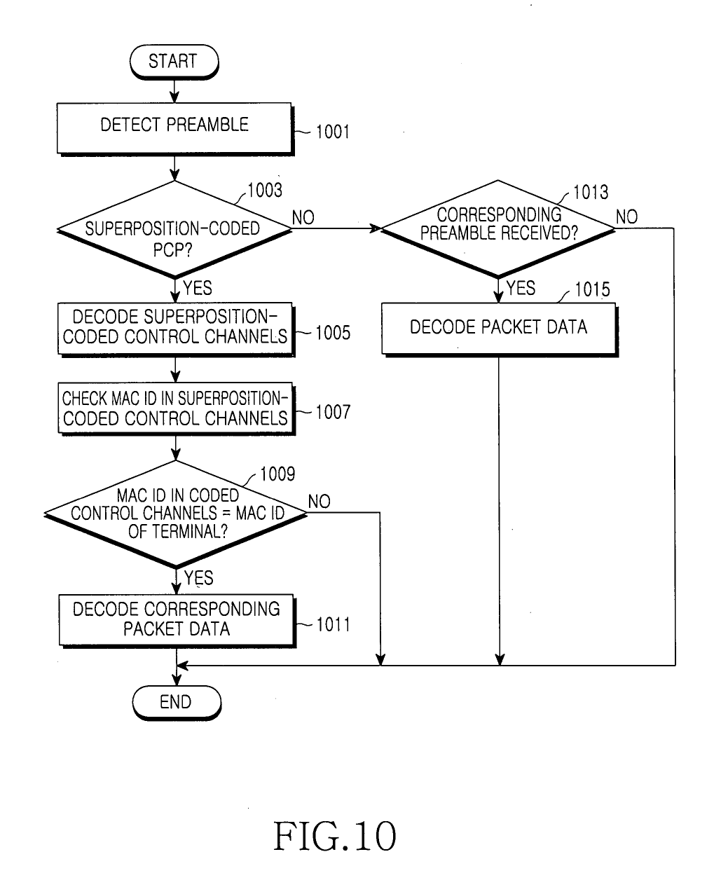

FIG. 10 illustrates a procedure for receiving packet data in a terminal's reception apparatus according to the third embodiment of the present invention.

Referring to FIG. 10, the terminal detects a preamble in step 1001. The terminal determines in step 1003 whether the detected preamble is a superposition-coded PCP.

If it is determined in step 1003 that the received preamble is a superposition-coded PCP, the terminal decodes a superposition-coded control channel in step 1005. The terminal checks a MAC ID in the decoded superposition-coded control channel in step 1007. Thereafter, the terminal determines in step 1009 whether the MAC ID in the decoded superposition-coded control channel is identical to its own MAC ID. That is, the terminal determines whether the received superposition-coded control channel is a control channel corresponding to its own MAC ID.

If the MAC ID in the decoded superposition-coded control channel is not identical to its own MAC ID, the terminal ends the procedure. However, if the MAC IDs are identical, the terminal decodes corresponding packet data in step 1011. The packet data decoding process includes a process of canceling interference from the superposition-coded control channel.

If it is determined in step 1003 that the received preamble is not a superposition-coded PCP, the terminal determines in step 1013 whether it has received a preamble corresponding to its own MAC ID. If the terminal has failed to receive the preamble corresponding to its own MAC ID, it ends the procedure. However, if the terminal has succeeded in receiving the preamble corresponding to its own MAC ID, the terminal decodes the corresponding packet data in step 1015.

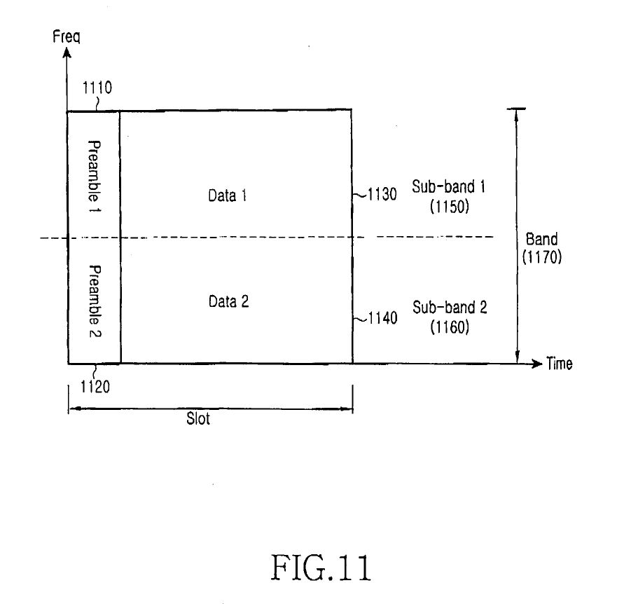

FIG. 11 illustrates a packet data transmission/reception method in a mobile communication system according to a fourth embodiment of the present invention. The method shown in FIG. 11, in which packet data is transmitted per sub-band in one slot, transmits preambles and packet data when performing BD on the preamble.

Referring to FIG. 11, during packet data transmission to a terminal, in order to provide the terminal with information indicating transmission of a plurality of packet data, a base station can transmit a preamble and packet data per sub-band in one slot, or can transmit one preamble and one packet data per band in one slot. The base station determines transmission packet data and a data rate thereof depending on DRCs received from terminals. For this, the terminal can transmit a DRC to the base station per sub-band, or transmit a DRC to the base station per band. That is, even when the terminal transmits a DRC per sub-band, the base station can transmit only one packet data to the corresponding terminal per band, or even when the terminal transmits a DRC per band, the base station can transmit packet data per sub-band if it desires to transmit the packet data in smaller size. Because a data rate of packet data transmitted from the base station is determined depending on the DRC, when a DRC is transmitted per band, a data rate for the case where packet data is transmitted per band and/or a data rate for the case where packet data is transmitted per sub-band are mapped to a DRC received at the base station from the terminal. The terminal receives a preamble per band/sub-band on the assumption that the data rate can be mapped to a DRC per band/sub-band.

Referring to FIG. 11, a first sub-band 1150 included in one band 1170 includes a preamble #1 1110 and data #1 1130, and a second sub-band 1160 includes a preamble #2 1120 and data #2 1140, thereby transmitting packet data per sub-band in one slot. The used preamble uses a preamble pattern for sub-band transmission. That is, preamble #1 1110, as it is transmitted independently, uses a specific preamble pattern suitable for the first sub-band 1150, and preamble #2 1120 uses a specific preamble pattern suitable for the second sub-band 1160. Preamble #1 1110 and preamble #2 1120 each include a MAC ID.

With reference to FIGS. 11 to 13, a description will now be made of a packet data transmission/reception method in a mobile communication system according to the fourth embodiment of the present invention.

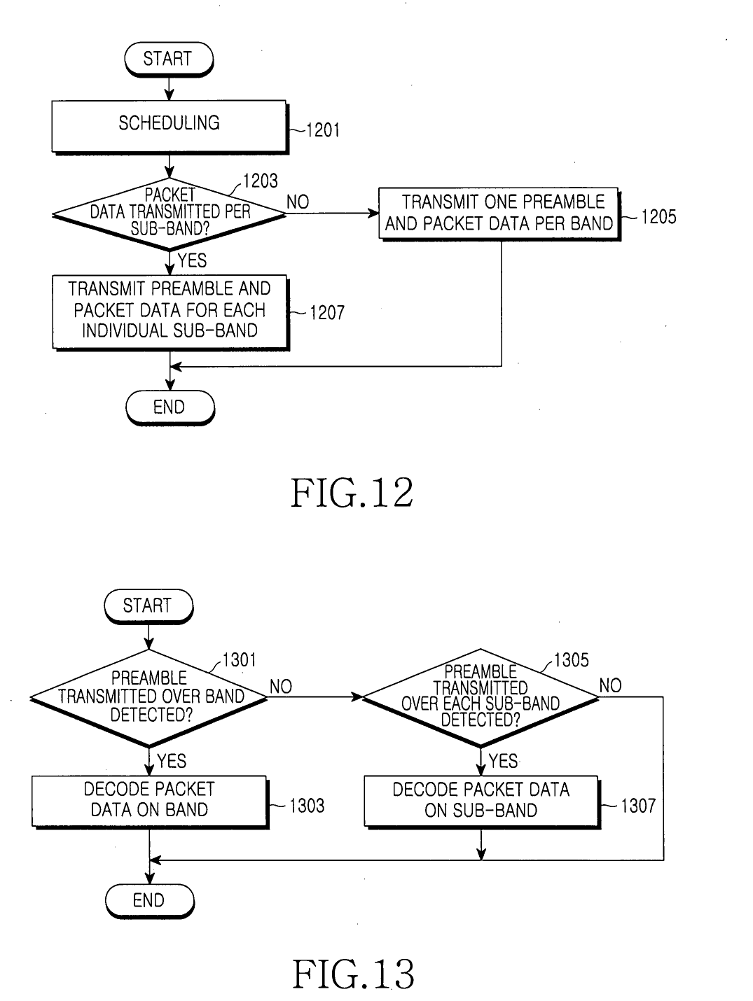

FIG. 12 illustrates a procedure for transmitting packet data in a base station's transmission apparatus according to the fourth embodiment of the present invention. Referring to FIG. 12, the base station performs scheduling in step 1201. Specifically, the base station determines to which terminal it will transmit packet data in the current slot, using DRC information received from several terminals.

The base station determines in step 1203 whether it will transmit packet data per sub-band in one slot. If the base station determines not to transmit packet data per sub-band in one slot, it transmits one preamble and one packet data per band in step 1205.

However, if the base station determines to transmit packet data per sub-band in one slot, it transmits a preamble and packet data per sub-band in step 1207.

FIG. 13 illustrates a procedure for receiving packet data in a terminal's reception apparatus according to the fourth embodiment of the present invention.

Referring to FIG. 13, the terminal determines in step 1301 whether it has detected a preamble that corresponds to its own MAC ID and is transmitted per band. This determination process is provided to allow the terminal to detect a preamble corresponding to its own MAC ID while performing BD on a preamble every slot.

If the terminal has detected a preamble that corresponds to its own MAC ID and is transmitted per band, the terminal decodes packet data on the corresponding band in step 1303.

However, if the terminal has failed in step 1301 to detect a preamble that corresponds to its own MAC ID and is transmitted per band, the terminal determines in step 1305 whether it has detected a preamble that corresponds to its own MAC ID and is transmitted per sub-band. If the terminal has failed to detect a preamble that corresponds to its own, MAC ID and is transmitted per sub-band, it ends the procedure. However, if the terminal has detected a preamble that corresponds to its own MAC ID and is transmitted per sub-band, the terminal decodes packet data on the sub-band in step 1307.

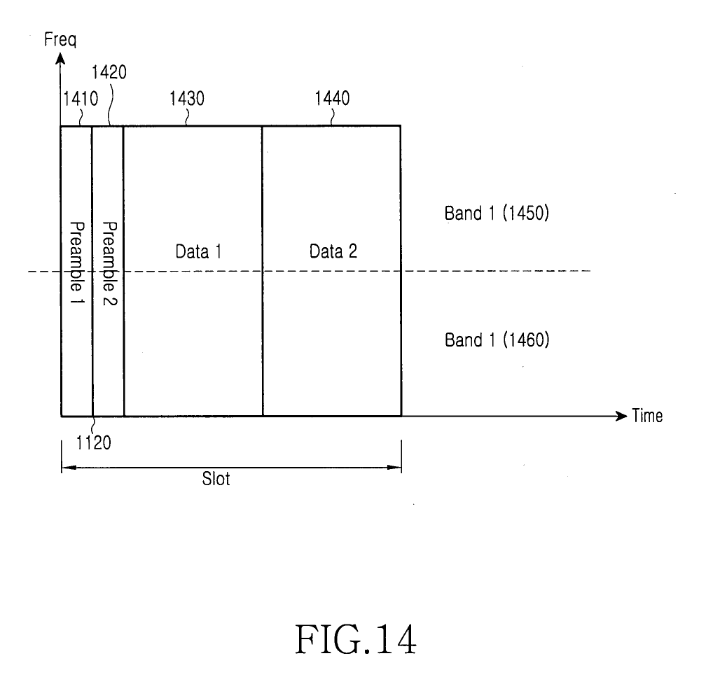

FIG. 14 illustrates a packet data transmission/reception method in a mobile communication system according to a fifth embodiment of the present invention. The method shown in FIG. 14, in which a plurality of packet data is transmitted per multiple bands, transmits preambles and packet data.

Referring to FIG. 14, during packet data transmission to a terminal, in order to provide the terminal with information indicating transmission of a plurality of packet data, a base station can transmit a plurality of packet data per multiple bands in one slot, or can transmit one packet data per band. This is because the terminal can transmit a DRC to the base station per band, or can transmit one DRC that represents several bands.

A data rate of transmission packet data is determined depending on the DRC, and when the terminal transmits the DRC per band, a data rate for the case where packet data is transmitted per band and/or a data rate for the case where packet data is transmitted per multiple bands are mapped to a DRC received at the base station from the terminal. If the base station, transmitting packet data over, for example, 3 bands, defines that it transmits 3 packet data separately over 3 bands or transmits one packet over 3 bands, the terminal detects a preamble for each possible case. In this case, the base station can provide the terminal with information indicating the possible multiple bands, in order to increase preamble detection performance.

Referring to FIG. 14, a preamble #1 1410, a preamble #2 1420, data #1 1430 and data #2 1440 constitute one slot over a band #1 1450 and a band #2 1460, and multiple packet data is transmitted per multiple bands. The preamble #1 1410 and the preamble #2 1420 each include a MAC ID.

With reference to FIGS. 14 to 16, a description will now be made of a packet data transmission/reception method in a mobile communication system according to the fifth embodiment of the present invention.

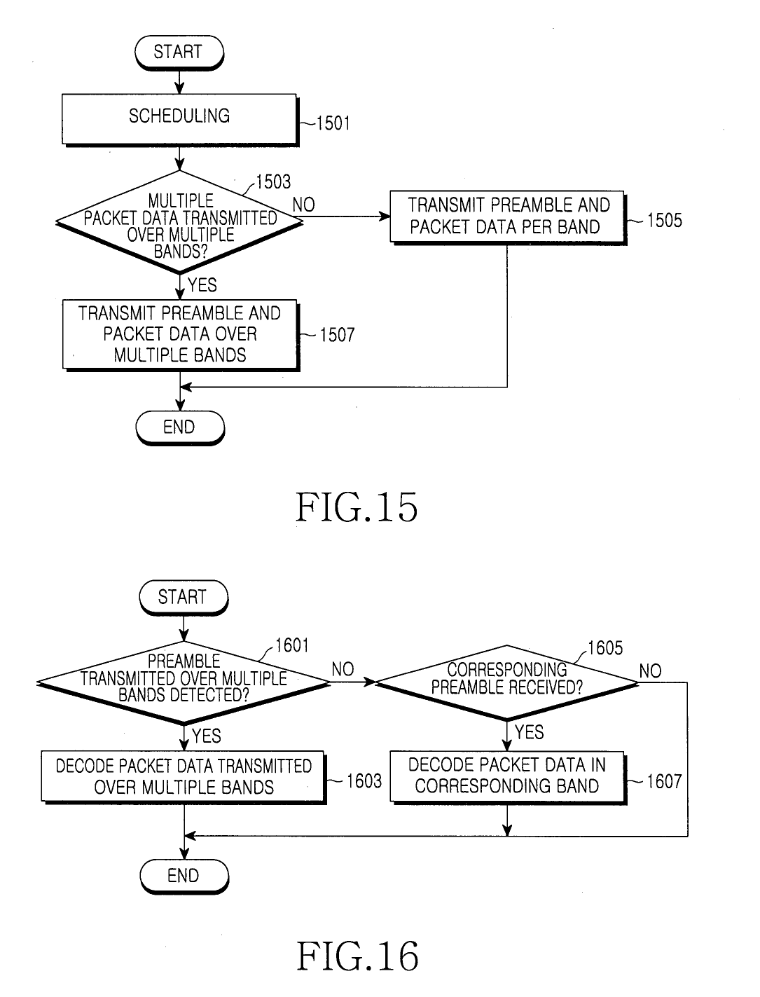

FIG. 15 illustrates a procedure for transmitting packet data in a base station's transmission apparatus according to the fifth embodiment of the present invention.

Referring to FIG. 15, the base station performs scheduling in step 1501. Specifically, the base station determines to which terminal it will transmit packet data in the current slot, using DRC information received from several terminals.

The base station determines in step 1503 whether it will transmit packet data over multiple bands in one slot. If the base station determines not to transmit packet data over multiple bands in one slot, the base station transmits preambles 1410 and 1420, and packet data 1430 and 1440 per band in step 1505. Here, the preambles 1410 and 1420 each include a MAC ID.

However, if the base station determines to transmit packet data over multiple bands in one slot, the base station transmits preambles 1410 and 1420, and packet data 1430 and 1440 over multiple bands in step 1507. Here, the preambles 1410 and 1420 each include a MAC ID.

FIG. 16 illustrates a procedure for receiving packet data in a terminal's reception apparatus according to the fifth embodiment of the present invention.

Referring to FIG. 16, the terminal determines in step 1601 whether it has detected a preamble that corresponds to its own MAC ID and is transmitted over multiple bands. If the terminal has detected a preamble that corresponds to its own MAC ID and is transmitted over multiple bands, it decodes the packet data transmitted over multiple bands in step 1603.

However, if it is determined in step 1601 that the terminal has failed to detect a preamble that corresponds to its own MAC ID and is transmitted over multiple bands, the terminal determines in step 1605 whether it has detected a preamble per band, which corresponds to its own MAC ID. If the terminal has failed to detect a preamble per band, which corresponds to its own MAC ID, the terminal ends the procedure. However, if the terminal has detected a preamble per band, which corresponds to its own MAC ID, the terminal decodes packet data in the corresponding band in step 1607.

If there is a need to prevent the terminal from detecting several preambles, the base station can set specific bands such that packet data is always transmitted over the corresponding bands.

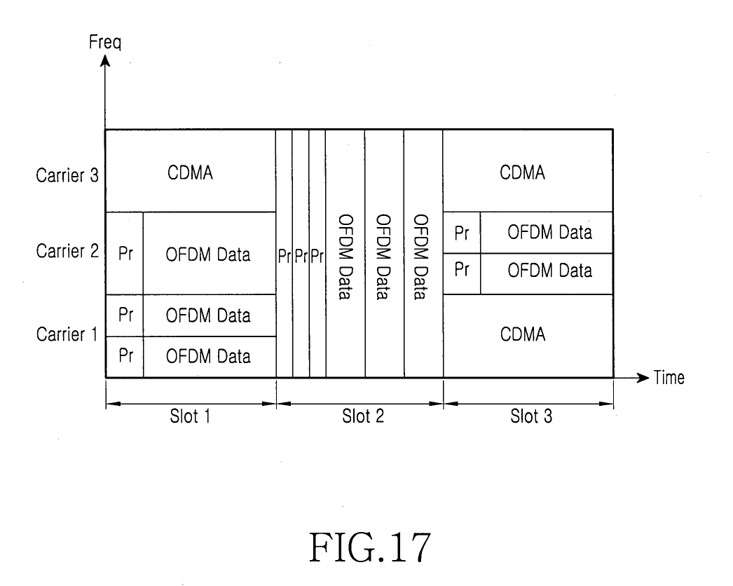

FIG. 17 illustrates exemplary application of the fourth and fifth embodiments of the present invention.

In the case shown in FIG. 17, CDMA and OFDM data is transmitted over 3 bands (or carriers) in a mixed manner. As to a first slot in the time axis, OFDM packet data is transmitted per sub-band in a first band, and one CDMA packet data is transmitted in a second band. This is the case where the fourth embodiment is applied to the first band. As to a second slot, OFDM packet data is transmitted over 3 bands, and this is the case where the fifth embodiment is applied.

A description will now be made of an operation performed when Hybrid ARQ (H-ARQ) is applied to data packets in the foregoing embodiments. For some of multiple data packets, a base station may not need to send a packet for retransmission as a terminal has succeeded in receiving the corresponding packets. In this case, the base station can transmit a data packet to a new terminal with corresponding frequency/time resources, or further allocate frequency/time resources to the reception-failed data packet. Even in this case, the base station can transmit a PCP and a coded control information channel, or only the coded control channel. As for transmission power, the base station can further allocate only the transmission power while maintaining the frequency/time resources for the reception-failed data packet, and in this case, the power allocation can be achieved without transmission of control information or preambles.

The foregoing embodiments can use coded control information channels instead of preambles in the case where a packet rate is different from a DRC received from a terminal even when one packet is transmitted in one slot, or in the case where a specific multi-antenna transmission scheme is used.

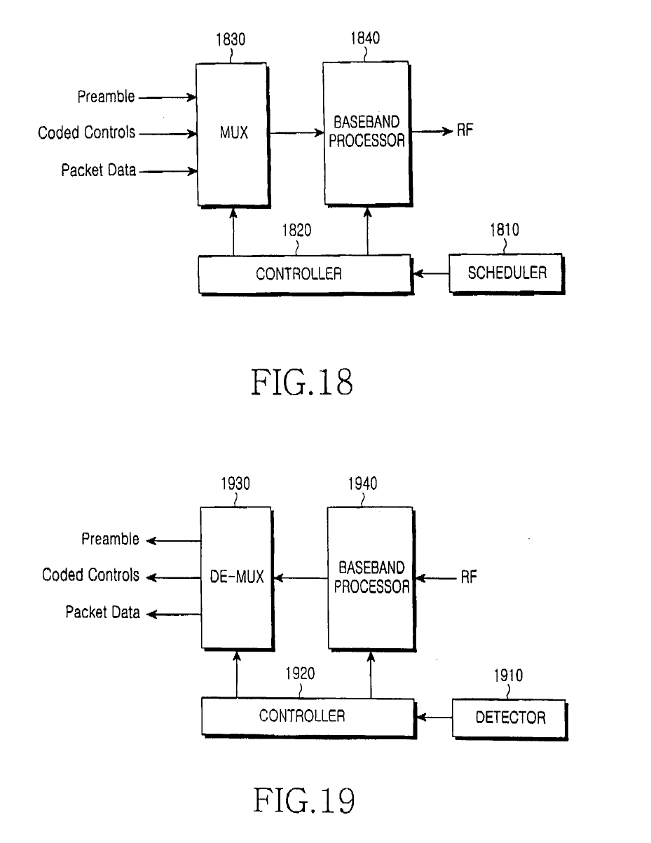

FIG. 18 illustrates a structure of a base station's transmission apparatus according to an embodiment of the present invention. Referring to FIG. 18, a base station includes a scheduler 1810, a controller 1820, a multiplexer 1830, and a baseband processor 1840.

The scheduler 1810 performs a scheduling operation for determining to which terminal the base station will transmit packet data in the current slot, using DRC information received from several terminals. The scheduler 1810 delivers the scheduling result to the controller 1820.

Based on the scheduling information from the scheduler 1810, the controller 1820 determines a method for transmitting a plurality of packet data in one slot, and controls the multiplexer 1830 and the baseband processor 1840 according to the determined method. As to the method for transmitting a plurality of packet data in one slot, the controller 1820 can transmit a plurality of packet data in one slot using a PCP like in the first embodiment, or can transmit a plurality of packet data using coded control channels without the PCP like in the second embodiment. In addition, the controller 1820 can transmit a plurality of packet data in one slot using a superposition-coded PCP and a superposition-coded control channel like in the third embodiment, or can transmit packet data per sub-band or can transmit packet data over the entire band like in the fourth embodiment. Further, the controller 1820 can transmit a plurality of packet data over multiple bands or can transmit packet data per band like in the fifth embodiment.

In addition, the controller 1820 controls the multiplexer 1830 according to information received from the scheduler 1810, indicating the number of packets transmitted in this slot. Further, the controller 1820, if it uses superposition coding, can control the coding in such a manner that the preambles and coded control channels use CDMA, and the data packets use OFDM.

The multiplexer 1830, under the control of the controller 1820, multiplexes a preamble, a coded control channel and packet data, and delivers the multiplexed result to the baseband processor 1840. The baseband processor 1840, under the control of the controller 1820, processes the multiplexed preamble, control channel and packet data into baseband signal, and delivers it to a Radio Frequency (RF) unit (not shown).

FIG. 19 illustrates a structure of a terminal's reception apparatus according to an embodiment of the present invention.

Referring to FIG. 19, a terminal includes a detector 1910, a controller 1920, a demultiplexer 1930, and a baseband processor 1940.

The detector 1910 detects a preamble and a coded control channel, and delivers the detected information to the controller 1920. Herein, as to the detected information, the detector 1910 can detect a PCP like in the first embodiment, or detect a coded control channel without the PCP like in the second embodiment. In addition, the detector 1910 can detect a superposition-coded PCP like in the third embodiment, or detect a preamble that corresponds to a MAC ID of the terminal and is transmitted over a band, or a preamble that corresponds to a MAC ID of the terminal and is transmitted per sub-band, like in the fourth embodiment. Moreover, the detector 1910 can detect a preamble that corresponds to a MAC ID of the terminal and is transmitted over multiple bands, or a preamble that corresponds to a MAC ID of the terminal and is transmitted per band, like in the fifth embodiment.

Based on the detected information, the controller 1920 determines whether a plurality of packet data is detected in one slot, and controls the demultiplexer 1930 and the baseband processor 1940 so as to receive the detected packet data.

The baseband processor 1940, under the control of the controller 1920, processes a signal received from an RF unit (not shown) into a baseband signal, and then delivers the baseband signal to the demultiplexer 1930.

The demultiplexer 1930, under the control of the controller 1920, demultiplexes the signal received from the baseband processor 1940, and then outputs a preamble, a coded control channel and packet data.

As can be understood from the foregoing description, the present invention has the following advantages.

The present invention can provide a packet data transmission/reception apparatus and method suitable for diversification of the number of packet data allocated to one slot and of data rates in a mobile communication system, thereby minimizing use of resources used for packet data transmission.

The present invention can transmit a plurality of packet data in one slot in a mobile communication system.

The present invention can transmit a plurality of packet data in one slot using a Primary Control Preamble (PCP).

The present invention can transmit a plurality of packet data in one slot by blind-decoding a coded control channel.

The present invention can transmit a plurality of packet data in one slot by superposition-coding a PCP and a coded control channel.

The present invention can transmit a plurality of packet data in one slot by transmitting packet data per sub-band.

The present invention can transmit a plurality of packet data in one slot by transmitting a plurality of packet data over multiple bands.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting packet data in a mobile communication system, the method comprising:
determining whether to transmit a plurality of packet data in one slot; and
transmitting a Primary Control Preamble (PCP) having a specific preamble pattern, a coded control channel, and packet data, if it is determined to transmit a plurality of packet data in one slot.

2. The method of claim 1, wherein the PCP includes information on the number of control channels.

3. The method of claim 1, wherein the coded control channel includes a Media Access Control Identifier (MAC ID).

4. The method of claim 1, further comprising:
transmitting a superposition-coded PCP, superposition-coded control channels, and the packet data, if it is determined to transmit a plurality of packet data in one slot.

5. The method of claim 1, further comprising:
transmitting a preamble and packet data per sub-band, if it is determined to transmit a plurality of packet data in one slot.

6. The method of claim 1, further comprising:
transmitting preambles and packet data over multiple bands, if it is determined to transmit a plurality of packet data in one slot.

7. A method for receiving packet data in a mobile communication system, the method comprising:
detecting a preamble from a signal received from a base station;
determining whether the detected preamble is a Primary Control Preamble (PCP) having a specific preamble pattern;
decoding coded control channels, and checking a Media Access Control Identifier (MAC ID) in the decoded control channels, if the detected preamble is a PCP;
determining whether the MAC ID in the control channels is identical to a MAC ID of a terminal; and
decoding corresponding packet data if the MAC IDs are identical.

8. A method for receiving packet data in a mobile communication system, the method comprising:
detecting a preamble through a signal received from a base station;
determining whether the detected preamble is a superposition-coded Primary Control Preamble (PCP) having a specific preamble pattern;
decoding superposition-coded control channels and checking a Media Access Control Identifier (MAC ID) in the decoded control channels, if the detected preamble is a superposition-coded PCP;
determining whether the MAC ID in the control channels is identical to a MAC ID of a terminal; and
decoding corresponding packet data if the MAC IDs are identical.

9. A method for receiving packet data in a mobile communication system, the method comprising:
detecting a preamble through a signal received from a base station;
determining whether the detected preamble is a preamble that corresponds to a Media Access Control Identifier (MAC ID) of a terminal and is transmitted per band;
decoding packet data on a corresponding band, if the detected preamble is a preamble that corresponds to a MAC ID of a terminal and is transmitted per band.

10. The method of claim 9, further comprising:
determining whether the detected preamble is a preamble that corresponds to a MAC ID of a terminal and is transmitted over multiple bands; and
decoding packet data transmitted over the corresponding multiple bands, if the detected preamble is a preamble that corresponds to a MAC ID of a terminal and is transmitted over multiple bands.

11. An apparatus for transmitting packet data in a mobile communication system, the apparatus comprising:
a scheduler for determining to which terminal it will transmit packet data in a current slot, using Data Rate Control (DRC) information received from a plurality of terminals; and
a controller for controlling transmission of a Primary Control Preamble (PCP) having a specific preamble pattern, a coded control channel and packet data according to the scheduling result, if it transmits a plurality of packet data in one slot.

12. An apparatus for receiving packet data in a mobile communication system, the apparatus comprising:
a detector for receiving a preamble received from a base station, detecting a coded control channel if the preamble is a Primary Control Preamble (PCP) having a specific preamble pattern, and providing the detected coded control channel information; and
a controller for controlling decoding of a plurality of packet data according to the detected information.
